(19) United States
(12) Patent Application Publication
(10) Pub. No.: US 2025/0130405 A1
(43) Pub. Date: Apr. 24, 2025

(54) LOW TOTAL TRACK LENGTH FOR LARGE SENSOR FORMAT

(71) Applicant: Corephotonics Ltd., Tel Aviv (IL)

(72) Inventors: Roy Rudnick, Tel Aviv (IL); Michael Dror, Tel Aviv (IL); Ephraim Goldenberg, Tel Aviv (IL)

(21) Appl. No.: 19/010,019

(22) Filed: Jan. 5, 2025

Related U.S. Application Data
(63) Continuation of application No. 18/645,450, filed on Apr. 25, 2024, now Pat. No. 12,222,473.
Application No. 18/645,450 is a continuation of application No. 18/314,936, filed on May 10, 2023, now Pat. No. 12,000,996.
Application No. 18/314,936 is a continuation of application No. 17/261,110, filed on Jan. 18, 2021, now Pat. No. 11,668,910.
(60) Provisional application No. 62/889,633, filed on Aug. 21, 2019.

(51) Int. Cl. G02B 13/00; G02B 9/64

(52) U.S. Cl. CPC G02B 13/0045; G02B 9/64

(57) ABSTRACT

Lens assemblies comprising from an object side to an image side, seven lens elements numbered L1-L7; an optical window; and an image sensor having a sensor diagonal length (SDL), wherein an exemplary lens assembly has a total track length TTL that includes the optical window an effective focal length EFL and a field of view (FOV), wherein TTL/EFL<1.100, wherein TTL/SDL<0.64, wherein FOV<90 degrees, wherein a normalized thickness standard deviation constant T_STD of at least four of the seven lens elements complies with T_STD<0.035, and wherein a focal length f₁ of lens element L1 fulfills f₁/EFL<0.95.

### CROSS REFERENCE TO RELATED APPLICATIONS

This is a continuation of U.S. patent application Ser. No. 18/645,450 filed Apr. 25, 2024 (now allowed), which was a continuation of U.S. patent application Ser. No. 18/314,936 filed May 10, 2023 (now U.S. Pat. No. 12,000,996), which was a continuation of U.S. patent application Ser. No. 17/261,110 filed Jan. 18, 2021 (now U.S. Pat. No. 11,668,910), which was a 371 application from international patent application PCT/IB2020/056923 filed Jul. 22, 2020, which claims the benefit of priority from U.S. provisional patent application No. 62/889,633 filed Aug. 21, 2019, which is incorporated herein by reference in its entirety.

### FIELD

Embodiments disclosed herein relate to optical lenses, and more particularly, to miniature lens assemblies.

### BACKGROUND

Digital camera modules are now standard in a variety of host devices. Such host devices include cellular telephones (smartphones), personal data assistants (PDAs), computers, and so forth. Cameras in smartphones in particular require a compact imaging lens system for good quality imaging and with a small total track length (TTL) relative to the size of the image sensor in such cameras. The image sensor size can always be expressed by the sensor diagonal, SDL.

### SUMMARY

In various exemplary embodiments, there are disclosed lens assemblies comprising: from an object side to an image side, seven lens elements numbered L1-L7, an optical window and an image sensor having a sensor diagonal length (SDL), wherein an exemplary lens assembly has a total track length TTL that includes the optical window, an effective focal length (EFL) and a field of view (FOV), wherein TTL/EFL<1.100, wherein TTL/SDL<0.64, wherein FOV<90 degrees, wherein a normalized thickness standard deviation constant T_STD of at least four of the seven lens elements complies with T_STD<0.035, and wherein a focal length f₁ of lens element L1 fulfills f₁/EFL<0.95.

In an embodiment, D/2 is an aperture radius and wherein a sign of z(r) from z(0.85*D/2) to z(D/2) is positive for surfaces LO₁, LI₁ of L1 and surfaces LO₂, LI₂ of L₂, and negative for surfaces LO₄, LI₄ of L4, LO₅, LI₅ of L5 LO₆, LI₆ of L₆ and LO₇, LI₇ of L7.

In some embodiments, ach element has a clear aperture (CA) and wherein a CA of lens elements L3 or L4 is the smallest of all CAs in the lens assembly.

In some embodiments, TTL/EFL<1.090.

In some embodiments, TTL/EFL<1.083.

In some embodiments, TTL/SDL<0.63.

In some embodiments, TTL/SDL<0.61.

In some embodiments, lens element L1 is convex on the object side.

In some embodiments, the lens elements have, starting with lens element L1, a power sign sequence of positive-negative-positive-negative-positive-positive-negative.

In some embodiments, the CT of at least 6 of the 7 lens elements complies CT/TTL<0.07.

In some embodiments, the T_STD of at least 5 of the 7 lens elements complies with T_STD<0.06.

In some embodiments, the T_STD of at least 5 of the 7 lens elements complies with

T_STD<0.05.

In some embodiments, f₁/EFL<0.9.

In some embodiments, f₁/EFL<0.85;

In some embodiments, a focal length f₅ of lens element L5 fulfills |f₅/EFL|>4.0.

In some embodiments, focal length f₅ of lens element L5 fulfills |f₅/EFL|>6.0.

In some embodiments, focal length f₅ of lens element L5 fulfills |f₅/EFL|>8.0.

In some embodiments, a focal length f₆ of lens element L6 fulfills f₆/EFL|>15.0.

In some embodiments, a focal length f₆ of lens element L6 fulfills f₆/EFL|>30.0.

In some embodiments, a focal length f₆ of lens element L6 fulfills f₆/EFL|>45.0.

In some embodiments, a normalized gap standard deviation constant G_STD of a gap between lens elements L1 and L2 complies with G_STD<0.006.

In some embodiments, a normalized gap standard deviation constant G_STD of a gap between lens elements L1 and L2 complies with G_STD<0.01.

In some embodiments, a normalized gap standard deviation constant G_STD of a gap between lens elements L1 and L2 complies with G_STD<0.007.

In some embodiments, SDL=12 mm and FOV<82.1 degrees.

### BRIEF DESCRIPTION OF THE DRAWINGS

Non-limiting examples of embodiments disclosed herein are described below with reference to figures attached hereto that are listed following this paragraph. Identical structures, elements or parts that appear in more than one figure are generally labeled with a same numeral in all the figures in which they appear. The drawings and descriptions are meant to illuminate and clarify embodiments disclosed herein and should not be considered limiting in any way. In the drawings:

FIG. 1 shows an exemplary embodiment of a lens assembly disclosed herein;

FIG. 2A shows an example for calculation of NT for calculation of T_STD using Eq. 3;

FIG. 2B shows an example of a lens profile obtained using the data in Table 3A;

FIG. 2C shows an example for calculation of the gap for calculation of G_STD using Eq. 5;

FIG. 2D shows an example of a profile of a gap between lens elements obtained using the data of Table 3C.

### DETAILED DESCRIPTION

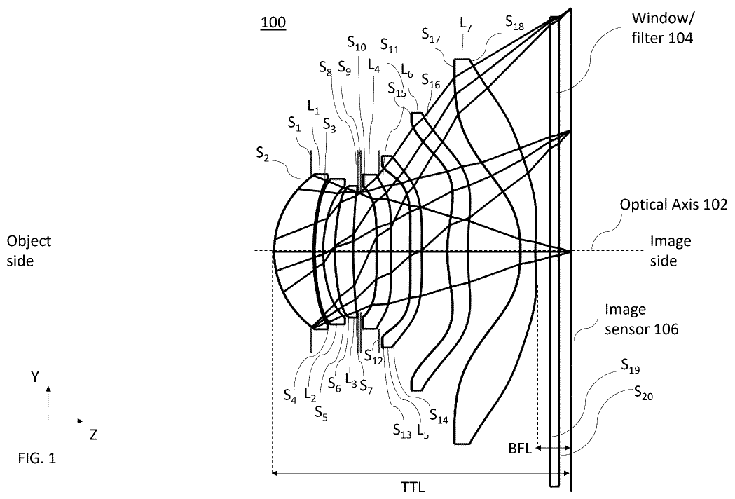

FIG. 1 shows an embodiment of an optical lens system disclosed herein and numbered 100. Embodiment 100 comprises in order from an object side to an image side a plurality of lens elements (here exemplarily seven lens elements numbered L1-L7) with a common optical axis 102. The lens further comprises three aperture stops marked S1 and two blocking surfaces S8 and S9. Lens element surfaces are marked “Si”, with S2 marking an object side surface of first lens element L1 and S18 marking an image side of lens element L7. Lens 100 further comprises an optional glass window 104 disposed between surface S18 and an image sensor 106 for image formation of an object. Image sensor 106 has a size characterized by an image sensor diagonal SDL.

The TTL is defined as the distance from the S₁ to the image sensor. FIG. 1 also shows a back focal length (BFL), defined as the distance from the last surface of the last lens element S_{2N} to the image sensor.

For convenience in some equations and relations presented below, lens element surfaces are also marked “LOᵢ” on the object side surface of lens element number i and “LIᵢ” on the image side surface of lens element number i.

### Surface Types

Surface types are defined in Table 1 and the coefficients for the surfaces are in Table 2:
a) Plano: flat surfaces, no curvature
b) Q type 1 (QT1) surface sag formula:

$$z ( r ) = \frac{c {r}^{2}}{1 + \sqrt{1 - ( 1 + k ) {c}^{2} {r}^{2}}} + {D}_{c o n} ( u ) \qquad ( Eq . l )$$

$${D}_{c o n} ( u ) = {u}^{4} {\sum }_{n = 0}^{N} {A}_{n} {Q}_{n}^{c o n} ( {u}^{2} )$$

$$u = \frac{r}{{r}_{n o r m}} , x = {u}^{2}$$

$${Q}_{0}^{c o n} ( x ) = 1$$

$${Q}_{1}^{c o n} = - ( 5 - 6 x )$$

$${Q}_{2}^{c o n} = 15 - 14 x ( 3 - 2 x )$$

$${Q}_{3}^{c o n} = - \{ 35 - 12 x [ 14 - x ( 21 - 10 x ) ] \}$$

$${Q}_{4}^{c o n} = 70 - 3 x \{ 168 - 5 x [ 84 - 11 x ( 8 - 3 x ) ] \}$$

$${Q}_{5}^{c o n} = - [ 126 - x ( 1260 - 11 x \{ 420 - x [ 720 - 13 x ( 45 - 14 x ) ] \} ) ]$$

where {z, r} are the standard cylindrical polar coordinates, c is the paraxial curvature of the surface, k is the conic parameter, rₙₒᵣₘ is generally one half of the surface's clear aperture, and Aₙ are the polynomial coefficients shown in lens data tables. z-axis is positive towards image.

In this specification, the term “RMOᵢ” refers to the aperture radius of a surface LOᵢ. The term “RMIᵢ” refers to the aperture radius of a surface LIᵢ.

In this specification, the term “normal thickness” (NT) is a function of r marked NTᵢ(r), and refers to the distance between the two surfaces of a lens element at coordinate r along the normal vector of the surface closer to object. Several functions and constants are defined per normal thickness:

For r=0, NTᵢ(r=0) is defined as the central thickness (CT) of lens element i (CTᵢ)

A “thickness average” (T_AVGᵢ) constant is given by:

$${T\_AVG}_{i} = \frac{1}{N} {\sum }_{k = 0}^{N} {NT}_{i} ( \frac{k \cdot {RMO}_{i}}{N} ) \qquad ( Eq . 2 )$$

where k is a discrete variable that runs from 0 to N, where N is an integer>10 (for this and all other functions and constants below).

A normalized thickness standard deviation (T_STDᵢ) constant is given by:

$${T\_STD}_{i} = \frac{1}{{RMO}_{i}} \sqrt{\frac{1}{N} {\sum }_{k = 0}^{N} {( {NT}_{i} ( \frac{k \cdot {RMO}_{i}}{N} ) - {T\_AVG}_{i} )}^{2}} \qquad ( Eq . 3 )$$

where k is a discrete variable that runs from 0 to N, and where T_AVGᵢ is defined as in (Eq.2).

In this specification, a “gap” or an “air gap” refers to the space between consecutive lens elements. Several functions and constants per gap are defined:

A “Gapᵢ(r)” function (for r=0, an “on-axis gap” OA_Gapᵢ) is defined as the thickness LIᵢ

Gapᵢ(r)=OA_Gapᵢ+z(r) of LIᵢ−z(r) of LOᵢ₊₁, where z(r) is it standard polar coordinate z. OA_Gapᵢ(r=0) of LIᵢ is the air thickness which is the air gap for r=0.

A “gap average” (G_AVGᵢ) constant is given by:

$${G\_AVG}_{i} = \frac{1}{N} {\sum }_{k = 0}^{N} {Gap}_{i} ( \frac{k \cdot R {min}_{i}}{N} ) \qquad ( Eq . 4 )$$

where k is a discrete variable that runs from 0 to N, where N is an integer >10, and where Rminᵢ is the minimum aperture radius value of surfaces {RMIᵢ, RMOᵢ₊₁};

A normalized gap standard deviation (G_STDᵢ) constant is given by:

TABLE 1
EFL = 6.75 mm, F# = 1.80, HFOV = 41.0 deg.

| | | | | | Aperture | | | | Focal |
|---|---|---|---|---|---|---|---|---|---|
| Surface | | | Curvature | Central | Radius | | | Abbe | Length |
| # | Comment | Type | Radius | Thickness | (D/2) | Material | Index | # | f |
| 1 | A.S | Plano | Infinity | −0.908 | 1.880 | | | | |
| 2 | L₁ | QT1 | 2.331 | 0.965 | 1.910 | Plastic | 1.54 | 55.9 | 6.55 |
| 3 | | | 5.744 | 0.032 | 1.800 | | | | |
| 4 | L₂ | QT1 | 4.828 | 0.208 | 1.790 | Plastic | 1.67 | 19.4 | −13.88 |
| 5 | | | 3.122 | 0.289 | 1.630 | | | | |
| 6 | L₃ | QT1 | 5.131 | 0.452 | 1.620 | Plastic | 1.54 | 55.9 | 17.40 |
| 7 | | | 10.834 | 0.110 | 1.530 | | | | |
| 8 | Stop | Plano | Infinity | 0.080 | 1.470 | | | | |
| 9 | Stop | Plano | Infinity | 0.383 | 1.480 | | | | |
| 10 | L₄ | QT1 | −725.052 | 0.358 | 1.620 | Plastic | 1.67 | 19.4 | −55.34 |
| 11 | | | 39.028 | −0.290 | 1.900 | | | | |
| 12 | Stop | Plano | Infinity | 0.760 | 1.905 | | | | |
| 13 | L₅ | QT1 | 16.247 | 0.281 | 2.150 | Plastic | 1.57 | 37.4 | 308.74 |
| 14 | | | 17.8 | 0.631 | 2.360 | | | | |
| 15 | L₆ | QT1 | 3.628 | 0.503 | 3.180 | Plastic | 1.60 | 28.3 | 11.50 |
| 16 | | | 7.205 | 1.295 | 3.420 | | | | |
| 17 | L₇ | QT1 | −4.684 | 0.369 | 4.500 | Plastic | 1.54 | 55.9 | −4.97 |
| 18 | | | 6.612 | 0.366 | 4.740 | | | | |
| 19 | Filter | Plano | Infinity | 0.2100 | 6.600 | Glass | 1.52 | 64.2 | |
| 20 | | | Infinity | 0.3000 | 6.600 | | | | |
| 21 | Image | Plano | Infinity | — | 6.200 | | | | |

${G\_STD}_{i} = \frac{1}{R {min}_{i}} \sqrt{{\frac{1}{N} {\sum }_{k = 0}^{N} {Gap}_{i} ( \frac{k \cdot R {min}_{i}}{N} ) - {G\_AVG}_{i} )}^{2}} and \qquad ( Eq . 5 )$ G_AVGᵢ is defined as in (Eq.4).
* Reference wavelength is 587.6 nm (d-line)
* Units are in mm except for index and Abbe #.
HFOV indicates half field of view

TABLE 2
Aspheric Coefficients

| Surface # | Rₙₒᵣₘ | A4 | A6 | A8 | A10 |
|---|---|---|---|---|---|
| 2 | 1.932 | 9.9940E−03 | −4.7500E−03 | −2.9987E−03 | −9.0698E−04 |
| 3 | 1.932 | 8.7490E−02 | 6.5977E−02 | 2.4979E−02 | 1.6077E−02 |
| 4 | 1.847 | 1.1859E−02 | 6.3506E−02 | 9.9150E−04 | 6.1490E−03 |
| 5 | 1.677 | 5.3358E−02 | 5.0530E−02 | −3.1217E−03 | −1.4993E−03 |
| 6 | 1.666 | 4.9696E−02 | 5.5310E−02 | 1.6953E−02 | 5.2611E−03 |
| 7 | 1.610 | −1.3866E−02 | 2.8507E−02 | 1.4152E−02 | 6.3734E−03 |
| 10 | 1.717 | −4.2084E−01 | −4.7698E−02 | −1.6836E−02 | −9.1824E−03 |
| 11 | 1.972 | −4.8789E−01 | 2.9587E−02 | 2.9227E−02 | 9.8845E−03 |
| 13 | 2.107 | −8.3702E−01 | −4.1159E−02 | 2.3372E−02 | 2.7289E−02 |
| 14 | 2.399 | −1.0545E+00 | 1.1548E−01 | 8.9981E−03 | 4.5560E−03 |
| 15 | 3.049 | −2.8037E+00 | 2.8375E−01 | 5.5647E−02 | −2.1641E−02 |
| 16 | 3.398 | −2.3573E+00 | 3.7757E−01 | 3.7804E−02 | −4.3086E−02 |
| 17 | 4.316 | 6.5309E−01 | 8.4437E−01 | −4.0343E−01 | 1.9637E−01 |
| 18 | 4.670 | −4.2765E+00 | 9.9979E−01 | −3.6429E−01 | 2.0098E−01 |

Aspheric Coefficients

| Surface # | A12 | A14 | A16 | A18 | A20 |
|---|---|---|---|---|---|
| 2 | −3.3763E−04 | −8.8742E−05 | −5.9283E−05 | 0.0000E+00 | 0.0000E+00 |
| 3 | 5.9956E−03 | 5.5077E−03 | 1.2558E−03 | 0.0000E+00 | 0.0000E+00 |
| 4 | −4.1612E−04 | 2.6196E−03 | 5.9748E−04 | 0.0000E+00 | 0.0000E+00 |
| 5 | −2.6943E−03 | −4.6173E−04 | −1.5513E−04 | 0.0000E+00 | 0.0000E+00 |
| 6 | 1.1659E−03 | 2.5551E−04 | 5.3420E−05 | 0.0000E+00 | 0.0000E+00 |
| 7 | 2.6374E−03 | 8.6554E−04 | 2.1797E−04 | 0.0000E+00 | 0.0000E+00 |
| 10 | −4.7317E−03 | −1.8472E−03 | −4.5679E−04 | 0.0000E+00 | 0.0000E+00 |
| 11 | 1.3992E−03 | −2.7093E−04 | −2.0424E−04 | 0.0000E+00 | 0.0000E+00 |
| 13 | 5.2402E−03 | 9.4540E−04 | 2.0861E−04 | 1.8088E−04 | 0.0000E+00 |
| 14 | −1.0297E−02 | 3.1228E−03 | 4.0339E−03 | 1.4174E−03 | 0.0000E+00 |
| 15 | −1.1934E−02 | 2.9700E−03 | 4.8437E−03 | −6.6223E−04 | −6.9121E−04 |
| 16 | 8.4277E−03 | 7.9687E−03 | 3.9145E−03 | −3.9617E−03 | −8.7507E−04 |
| 17 | −6.6969E−02 | 2.4300E−02 | −6.4810E−03 | 1.6529E−03 | −1.0244E−04 |
| 18 | −1.0479E−01 | 3.6269E−02 | −1.0994E−02 | 4.8537E−03 | −4.6735E−04 |

### Calculation of T_STD for the Lens Based on the Original Specification

Using Eq. 2 and Eq. 3, one can calculate the thickness of the lens (NT) in 100 steps (N). The thickness is calculated in each step using the ‘SAGG’ operand in every iteration. The equation of the thickness using the front and rear sag of every lens and the central thickness (CT) is:

$$N T = CT - front sag + rear sag$$

For example, see lens element 7, FIG. 3A. The values of the front and rear sag for lens element 7 are given in Table 3A:

TABLE 3A

| | front sag | rear sag |
|---|---|---|
| 0 | 0 | 0 |
| 0.01 | −0.0002 | 0.0002 |
| 0.02 | −0.0009 | 0.0006 |
| 0.03 | −0.002 | 0.0014 |
| 0.04 | −0.0035 | 0.0024 |
| 0.05 | −0.0056 | 0.0036 |
| 0.06 | −0.0082 | 0.0051 |
| 0.07 | −0.0113 | 0.0067 |
| 0.08 | −0.0151 | 0.0085 |
| 0.09 | −0.0195 | 0.0104 |
| 0.1 | −0.0246 | 0.0122 |
| 0.11 | −0.0304 | 0.0141 |
| 0.12 | −0.0371 | 0.0158 |
| 0.13 | −0.0447 | 0.0174 |
| 0.14 | −0.0531 | 0.0188 |
| 0.15 | −0.0626 | 0.0199 |
| 0.16 | −0.073 | 0.0206 |
| 0.17 | −0.0846 | 0.021 |
| 0.18 | −0.0972 | 0.0209 |
| 0.19 | −0.1111 | 0.0203 |
| 0.2 | −0.1261 | 0.0191 |
| 0.21 | −0.1423 | 0.0174 |
| 0.22 | −0.1598 | 0.015 |
| 0.23 | −0.1785 | 0.012 |
| 0.24 | −0.1984 | 0.0083 |
| 0.25 | −0.2196 | 0.0039 |
| 0.26 | −0.242 | −0.0012 |
| 0.27 | −0.2657 | −0.007 |
| 0.28 | −0.2905 | −0.0135 |
| 0.29 | −0.3164 | −0.0207 |
| 0.3 | −0.3434 | −0.0287 |
| 0.31 | −0.3714 | −0.0372 |
| 0.32 | −0.4004 | −0.0464 |
| 0.33 | −0.4303 | −0.0562 |
| 0.34 | −0.461 | −0.0666 |
| 0.35 | −0.4924 | −0.0776 |
| 0.36 | −0.5245 | −0.089 |
| 0.37 | −0.5571 | −0.1009 |
| 0.38 | −0.5902 | −0.1132 |
| 0.39 | −0.6237 | −0.1259 |
| 0.4 | −0.6575 | −0.1389 |
| 0.41 | −0.6915 | −0.1522 |
| 0.42 | −0.7256 | −0.1658 |
| 0.43 | −0.7597 | −0.1796 |
| 0.44 | −0.7938 | −0.1936 |
| 0.45 | −0.8277 | −0.2078 |
| 0.46 | −0.8613 | −0.2221 |
| 0.47 | −0.8946 | −0.2366 |
| 0.48 | −0.9276 | −0.2512 |
| 0.49 | −0.9601 | −0.2659 |
| 0.5 | −0.992 | −0.2807 |
| 0.51 | −1.0234 | −0.2957 |
| 0.52 | −1.0542 | −0.3107 |
| 0.53 | −1.0842 | −0.3259 |
| 0.54 | −1.1135 | −0.3411 |
| 0.55 | −1.1421 | −0.3566 |
| 0.56 | −1.1698 | −0.3722 |
| 0.57 | −1.1966 | −0.3881 |
| 0.58 | −1.2227 | −0.4041 |
| 0.59 | −1.2478 | −0.4205 |
| 0.6 | −1.2719 | −0.4371 |
| 0.61 | −1.2952 | −0.454 |
| 0.62 | −1.3175 | −0.4714 |
| 0.63 | −1.3389 | −0.4891 |
| 0.64 | −1.3594 | −0.5073 |
| 0.65 | −1.3788 | −0.526 |
| 0.66 | −1.3974 | −0.5451 |
| 0.67 | −1.415 | −0.5649 |
| 0.68 | −1.4317 | −0.5852 |
| 0.69 | −1.4475 | −0.6062 |
| 0.7 | −1.4624 | −0.6278 |
| 0.71 | −1.4764 | −0.6501 |
| 0.72 | −1.4895 | −0.6731 |
| 0.73 | −1.5019 | −0.6968 |
| 0.74 | −1.5134 | −0.7213 |
| 0.75 | −1.5242 | −0.7465 |
| 0.76 | −1.5343 | −0.7725 |
| 0.77 | −1.5436 | −0.7991 |
| 0.78 | −1.5522 | −0.8265 |
| 0.79 | −1.5603 | −0.8545 |
| 0.8 | −1.5676 | −0.8832 |
| 0.81 | −1.5744 | −0.9125 |
| 0.82 | −1.5807 | −0.9423 |
| 0.83 | −1.5864 | −0.9726 |
| 0.84 | −1.5916 | −1.0032 |
| 0.85 | −1.5964 | −1.0342 |
| 0.86 | −1.6006 | −1.0653 |
| 0.87 | −1.6045 | −1.0965 |
| 0.88 | −1.6079 | −1.1277 |
| 0.89 | −1.611 | −1.1589 |
| 0.9 | −1.6136 | −1.1898 |
| 0.91 | −1.6158 | −1.2205 |
| 0.92 | −1.6177 | −1.2509 |
| 0.93 | −1.6192 | −1.2809 |
| 0.94 | −1.6202 | −1.3105 |
| 0.95 | −1.6208 | −1.3398 |
| 0.96 | −1.6209 | −1.3686 |
| 0.97 | −1.6205 | −1.3972 |
| 0.98 | −1.6198 | −1.4256 |
| 0.99 | −1.6191 | −1.4537 |
| 1 | −1.6196 | −1.4817 |

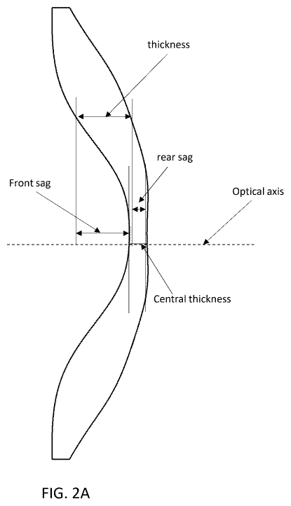

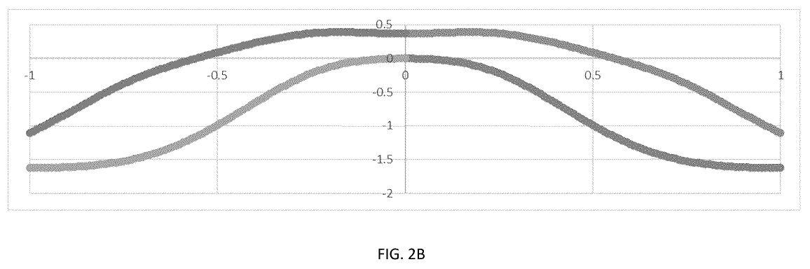

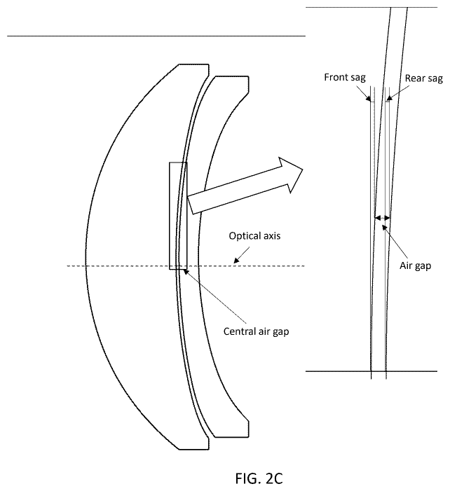

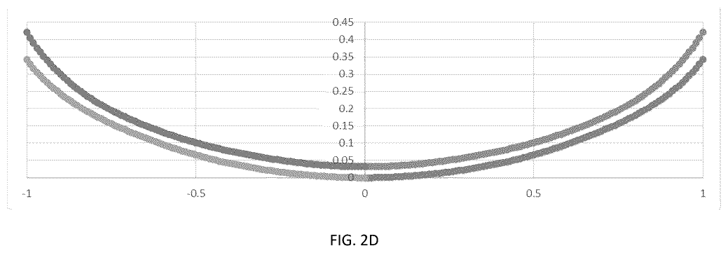

The central thickness of lens element 7 is 0.3688 mm. From the data, one can plot the lens profile in FIG. 2B. The thickness profile of lens 7 is given in Table 3B:

TABLE 3B

| | |
|---|---|
| 0 | 0.3688 |
| 0.01 | 0.3692 |
| 0.02 | 0.3703 |
| 0.03 | 0.3722 |
| 0.04 | 0.3747 |
| 0.05 | 0.378 |
| 0.06 | 0.3821 |
| 0.07 | 0.3868 |
| 0.08 | 0.3924 |
| 0.09 | 0.3987 |
| 0.1 | 0.4056 |
| 0.11 | 0.4133 |
| 0.12 | 0.4217 |
| 0.13 | 0.4309 |
| 0.14 | 0.4407 |
| 0.15 | 0.4513 |
| 0.16 | 0.4624 |
| 0.17 | 0.4744 |
| 0.18 | 0.4869 |
| 0.19 | 0.5002 |
| 0.2 | 0.514 |
| 0.21 | 0.5285 |
| 0.22 | 0.5436 |
| 0.23 | 0.5593 |
| 0.24 | 0.5755 |
| 0.25 | 0.5923 |
| 0.26 | 0.6096 |
| 0.27 | 0.6275 |
| 0.28 | 0.6458 |
| 0.29 | 0.6645 |
| 0.3 | 0.6835 |
| 0.31 | 0.703 |
| 0.32 | 0.7228 |
| 0.33 | 0.7429 |
| 0.34 | 0.7632 |
| 0.35 | 0.7836 |
| 0.36 | 0.8043 |
| 0.37 | 0.825 |
| 0.38 | 0.8458 |
| 0.39 | 0.8666 |
| 0.4 | 0.8874 |
| 0.41 | 0.9081 |
| 0.42 | 0.9286 |
| 0.43 | 0.9489 |
| 0.44 | 0.969 |
| 0.45 | 0.9887 |
| 0.46 | 1.008 |
| 0.47 | 1.0268 |
| 0.48 | 1.0452 |
| 0.49 | 1.063 |
| 0.5 | 1.0801 |
| 0.51 | 1.0965 |
| 0.52 | 1.1123 |
| 0.53 | 1.1271 |
| 0.54 | 1.1412 |
| 0.55 | 1.1543 |
| 0.56 | 1.1664 |
| 0.57 | 1.1773 |
| 0.58 | 1.1874 |
| 0.59 | 1.1961 |
| 0.6 | 1.2036 |
| 0.61 | 1.21 |
| 0.62 | 1.2149 |
| 0.63 | 1.2186 |
| 0.64 | 1.2209 |
| 0.65 | 1.2216 |
| 0.66 | 1.2211 |
| 0.67 | 1.2189 |
| 0.68 | 1.2153 |
| 0.69 | 1.2101 |
| 0.7 | 1.2034 |
| 0.71 | 1.1951 |
| 0.72 | 1.1852 |
| 0.73 | 1.1739 |
| 0.74 | 1.1609 |
| 0.75 | 1.1465 |
| 0.76 | 1.1306 |
| 0.77 | 1.1133 |
| 0.78 | 1.0945 |
| 0.79 | 1.0746 |
| 0.8 | 1.0532 |
| 0.81 | 1.0307 |
| 0.82 | 1.0072 |
| 0.83 | 0.9826 |
| 0.84 | 0.9572 |
| 0.85 | 0.931 |
| 0.86 | 0.9041 |
| 0.87 | 0.8768 |
| 0.88 | 0.849 |
| 0.89 | 0.8209 |
| 0.9 | 0.7926 |
| 0.91 | 0.7641 |
| 0.92 | 0.7356 |
| 0.93 | 0.7071 |
| 0.94 | 0.6785 |
| 0.95 | 0.6498 |
| 0.96 | 0.6211 |
| 0.97 | 0.5921 |
| 0.98 | 0.563 |
| 0.99 | 0.5342 |
| 1 | 0.5067 |

Then, the average thickness (T_AVGᵢ) is calculated using Eq. 2 and the normalized standard deviation (T_STDᵢ) using Eq. 3, where RMOᵢ refers to the aperture radius of a surface LOᵢ.

### Calculation of G_STD for the Lens Based on the Original Specification

Using Eq. 4 and Eq. 5, one can calculate the thickness of the air gap (Gap) in 100 steps (N). The thickness is calculated in each step using the ‘SAGG’ operand in every iteration. The equation of the thickness using the front and rear sag of every surface and the central air gap is:

$$Gap = central air gap - front sag + rear sag$$

For example, see the air gap between lens elements 1 and 2 in FIG. 2C. The values of the front and rear sag for air gap between lens elements 1 and 2 are given in Table 3C:

TABLE 3C

| | front sag | rear sag |
|---|---|---|
| 0 | 0 | 0 |
| 0.01 | 0 | 0 |
| 0.02 | 0.0001 | 0.0001 |
| 0.03 | 0.0003 | 0.0003 |
| 0.04 | 0.0004 | 0.0005 |
| 0.05 | 0.0007 | 0.0008 |
| 0.06 | 0.001 | 0.0012 |
| 0.07 | 0.0014 | 0.0016 |
| 0.08 | 0.0018 | 0.0021 |
| 0.09 | 0.0022 | 0.0026 |
| 0.1 | 0.0028 | 0.0033 |
| 0.11 | 0.0033 | 0.0039 |
| 0.12 | 0.004 | 0.0047 |
| 0.13 | 0.0046 | 0.0054 |
| 0.14 | 0.0054 | 0.0063 |
| 0.15 | 0.0061 | 0.0072 |
| 0.16 | 0.007 | 0.0081 |
| 0.17 | 0.0078 | 0.0091 |
| 0.18 | 0.0088 | 0.0102 |
| 0.19 | 0.0097 | 0.0113 |
| 0.2 | 0.0107 | 0.0124 |
| 0.21 | 0.0118 | 0.0136 |
| 0.22 | 0.0129 | 0.0148 |
| 0.23 | 0.0141 | 0.0161 |
| 0.24 | 0.0153 | 0.0175 |
| 0.25 | 0.0165 | 0.0188 |
| 0.26 | 0.0178 | 0.0202 |
| 0.27 | 0.0192 | 0.0217 |
| 0.28 | 0.0206 | 0.0232 |
| 0.29 | 0.022 | 0.0247 |
| 0.3 | 0.0235 | 0.0263 |
| 0.31 | 0.0251 | 0.028 |
| 0.32 | 0.0267 | 0.0296 |
| 0.33 | 0.0283 | 0.0314 |
| 0.34 | 0.03 | 0.0331 |
| 0.35 | 0.0318 | 0.035 |
| 0.36 | 0.0336 | 0.0368 |
| 0.37 | 0.0355 | 0.0388 |
| 0.38 | 0.0374 | 0.0407 |
| 0.39 | 0.0394 | 0.0428 |
| 0.4 | 0.0414 | 0.0449 |
| 0.41 | 0.0435 | 0.047 |
| 0.42 | 0.0457 | 0.0492 |
| 0.43 | 0.048 | 0.0515 |
| 0.44 | 0.0503 | 0.0538 |
| 0.45 | 0.0527 | 0.0562 |
| 0.46 | 0.0551 | 0.0586 |
| 0.47 | 0.0576 | 0.0612 |
| 0.48 | 0.0602 | 0.0637 |
| 0.49 | 0.0629 | 0.0664 |
| 0.5 | 0.0656 | 0.0691 |
| 0.51 | 0.0684 | 0.0719 |
| 0.52 | 0.0713 | 0.0748 |
| 0.53 | 0.0742 | 0.0777 |
| 0.54 | 0.0772 | 0.0807 |
| 0.55 | 0.0803 | 0.0838 |
| 0.56 | 0.0835 | 0.087 |
| 0.57 | 0.0867 | 0.0902 |
| 0.58 | 0.09 | 0.0935 |
| 0.59 | 0.0933 | 0.0969 |
| 0.6 | 0.0967 | 0.1003 |
| 0.61 | 0.1002 | 0.1039 |
| 0.62 | 0.1038 | 0.1075 |
| 0.63 | 0.1073 | 0.1111 |
| 0.64 | 0.111 | 0.1149 |
| 0.65 | 0.1147 | 0.1187 |
| 0.66 | 0.1185 | 0.1227 |
| 0.67 | 0.1223 | 0.1267 |
| 0.68 | 0.1262 | 0.1308 |
| 0.69 | 0.1302 | 0.135 |
| 0.7 | 0.1343 | 0.1393 |
| 0.71 | 0.1384 | 0.1438 |
| 0.72 | 0.1426 | 0.1483 |
| 0.73 | 0.1469 | 0.153 |
| 0.74 | 0.1512 | 0.1579 |
| 0.75 | 0.1557 | 0.1629 |
| 0.76 | 0.1603 | 0.1681 |
| 0.77 | 0.165 | 0.1735 |
| 0.78 | 0.1699 | 0.1791 |
| 0.79 | 0.1749 | 0.1849 |
| 0.8 | 0.18 | 0.1909 |
| 0.81 | 0.1853 | 0.1972 |
| 0.82 | 0.1908 | 0.2037 |
| 0.83 | 0.1965 | 0.2105 |
| 0.84 | 0.2024 | 0.2176 |
| 0.85 | 0.2086 | 0.225 |
| 0.86 | 0.2149 | 0.2328 |
| 0.87 | 0.2215 | 0.2408 |
| 0.88 | 0.2284 | 0.2492 |
| 0.89 | 0.2355 | 0.258 |
| 0.9 | 0.2429 | 0.2671 |
| 0.91 | 0.2507 | 0.2767 |
| 0.92 | 0.2588 | 0.2866 |
| 0.93 | 0.2672 | 0.2971 |
| 0.94 | 0.276 | 0.308 |
| 0.95 | 0.2853 | 0.3194 |
| 0.96 | 0.2951 | 0.3315 |
| 0.97 | 0.3056 | 0.3443 |
| 0.98 | 0.3168 | 0.3579 |
| 0.99 | 0.3288 | 0.3726 |
| 1 | 0.3421 | 0.3886 |

The central air gap between lens 1 and lens 2 is 0.0316 mm. From the data, one can then plot the gap profile in FIG. 2D. The air gap thickness profile of air gap between lens 1 and lens 2 is given in Table 3D:

TABLE 3D

| | |
|---|---|
| 0 | 0.0316 |
| 0.01 | 0.0316 |
| 0.02 | 0.0316 |
| 0.03 | 0.0316 |
| 0.04 | 0.0317 |
| 0.05 | 0.0317 |
| 0.06 | 0.0318 |
| 0.07 | 0.0318 |
| 0.08 | 0.0319 |
| 0.09 | 0.032 |
| 0.1 | 0.0321 |
| 0.11 | 0.0322 |
| 0.12 | 0.0323 |
| 0.13 | 0.0324 |
| 0.14 | 0.0325 |
| 0.15 | 0.0327 |
| 0.16 | 0.0327 |
| 0.17 | 0.0329 |
| 0.18 | 0.033 |
| 0.19 | 0.0332 |
| 0.2 | 0.0333 |
| 0.21 | 0.0334 |
| 0.22 | 0.0335 |
| 0.23 | 0.0336 |
| 0.24 | 0.0338 |
| 0.25 | 0.0339 |
| 0.26 | 0.034 |
| 0.27 | 0.0341 |
| 0.28 | 0.0342 |
| 0.29 | 0.0343 |
| 0.3 | 0.0344 |
| 0.31 | 0.0345 |
| 0.32 | 0.0345 |
| 0.33 | 0.0347 |
| 0.34 | 0.0347 |
| 0.35 | 0.0348 |
| 0.36 | 0.0348 |
| 0.37 | 0.0349 |
| 0.38 | 0.0349 |
| 0.39 | 0.035 |
| 0.4 | 0.0351 |
| 0.41 | 0.0351 |
| 0.42 | 0.0351 |
| 0.43 | 0.0351 |
| 0.44 | 0.0351 |
| 0.45 | 0.0351 |
| 0.46 | 0.0351 |
| 0.47 | 0.0352 |
| 0.48 | 0.0351 |
| 0.49 | 0.0351 |
| 0.5 | 0.0351 |
| 0.51 | 0.0351 |
| 0.52 | 0.0351 |
| 0.53 | 0.0351 |
| 0.54 | 0.0351 |
| 0.55 | 0.0351 |
| 0.56 | 0.0351 |
| 0.57 | 0.0351 |
| 0.58 | 0.0351 |
| 0.59 | 0.0352 |
| 0.6 | 0.0352 |
| 0.61 | 0.0353 |
| 0.62 | 0.0353 |
| 0.63 | 0.0354 |
| 0.64 | 0.0355 |
| 0.65 | 0.0356 |
| 0.66 | 0.0358 |
| 0.67 | 0.036 |
| 0.68 | 0.0362 |
| 0.69 | 0.0364 |
| 0.7 | 0.0366 |
| 0.71 | 0.037 |
| 0.72 | 0.0373 |
| 0.73 | 0.0377 |
| 0.74 | 0.0383 |
| 0.75 | 0.0388 |
| 0.76 | 0.0394 |
| 0.77 | 0.0401 |
| 0.78 | 0.0408 |
| 0.79 | 0.0416 |
| 0.8 | 0.0425 |
| 0.81 | 0.0435 |
| 0.82 | 0.0445 |
| 0.83 | 0.0456 |
| 0.84 | 0.0468 |
| 0.85 | 0.048 |
| 0.86 | 0.0495 |
| 0.87 | 0.0509 |
| 0.88 | 0.0524 |
| 0.89 | 0.0541 |
| 0.9 | 0.0558 |
| 0.91 | 0.0576 |
| 0.92 | 0.0594 |
| 0.93 | 0.0615 |
| 0.94 | 0.0636 |
| 0.95 | 0.0657 |
| 0.96 | 0.068 |
| 0.97 | 0.0703 |
| 0.98 | 0.0727 |
| 0.99 | 0.0754 |
| 1 | 0.0781 |

Then, one can calculate the gap average (G_AVGᵢ) using Eq. 4, and the normalized standard deviation (G_STDᵢ) using Eq. 5 where Rminᵢ is the minimum aperture radius value of surfaces {RMIᵢ, RMOᵢ₊₁}.

Using Eq. 3 and the parameters given in Tables 1 and 2, the following values are calculated for T_STD for lens elements L1 . . . −L7:

| | |
|---|---|
| L1 | 0.086029 |
| L2 | 0.043499 |
| L3 | 0.02944 |
| L4 | 0.019337 |
| L5 | 0.022676 |
| L6 | 0.02971 |
| L7 | 0.064714 |

Using Eq. 5 and the parameters given in Tables 1 and 2, the following values are calculated for G_STD for gaps L1-2 . . . −L6-7:

| | |
|---|---|
| L1-2 | 0.005903 |
| L2-3 | 0.035826 |
| L3-4 | 0.059022 |
| L4-5 | 0.013084 |
| L5-6 | 0.076052 |
| L6-7 | 0.259283 |

Table 4 below summarizes the design characteristics and parameters as they appear in the example listed above. These characteristics help to achieve the goal of a compact lens (i.e. small TTL) with a large image height (i.e. large SDL) and small F number (F #):

TABLE 4

| | |
|---|---|
| “AA”: | AA₁ ≡ TTL/EFL < 1.100, AA₂ ≡ TTL/EFL < 1.090, AA₃ ≡ TTL/EFL < 1.083; |
| “BB”: | BB₁ ≡ TTL/SDL < 0.64, BB₂ ≡ TTL/ SDL < 0.63, BB₃ ≡ TTL/SDL < 0.61; |
| “CC”: | Lens 1 is convex on object side; |
| “DD”: | the CA of Lens 3 or Lens 4 is the smallest of all element CAs; |
| “EE”: | power sign sequence: +−+−++−; |
| “FF”: | The central thickness (CT) of at least 6 of the 7 lens elements complies with: FF₁ = |
| | CT/TTL < 0.07; |
| “GG”: | The T_STD of at least 5 of the 7 lens elements complies with: GG₁ ≡ T_STD < 0.06, |
| | GG₂ ≡ T_STDCT < 0.05; |
| “HH”: | The T_STD of at least 4 of the 7 lens elements complies with: HH₁ ≡ T_STD < 0.035, |
| | HH₂ ≡ T_STD/CT < 0.03; |
| “II” | Sign of z(r) from z(0.85*D/2) to z(D/2) is positive for surfaces LO₁, LI₁, LO₂, LI₂, |
| | and negative for surfaces LO₄, LI₄, LO₅, LI₅, LO₆, LI₆, LO₇, LI₇; |
| “JJ”: | JJ₁ ≡ f₁/EFL < 0.95, JJ₂ ≡ f₁/EFL < 0.9, JJ₃ ≡ f₁/EFL < 0.85; |
| “KK”: | KK₁ ≡ \|f₅/EFL\| > 4.0, KK₂ ≡ \|f₅/EFL\| > 6.0, KK₃ ≡ \|f₅/EFL\| > 8.0; |
| “LL”: | LL₁ ≡ \|f₆/EFL\| > 15.0, LL₂ ≡ \|f₆/EFL\| > 30.0, LL₂ ≡ \|f₆/EFL\| > 45.0; |
| “MM”: | Gap between Lens 1 and Lens 2 that complies with: MM₁ ≡ G_STD < 0.006, |
| | MM₂ ≡ G_STD < 0.01 and MM₃ ≡ G_STD < 0.007; |
| “NN”: | for the given SDL (12 mm), 0 ≤ FOV < 82.1 degrees. |

In summary, various lens assembly embodiments disclosed herein have or fulfill different design characteristics and parameters listed in the Tables above.

While this disclosure describes a limited number of embodiments, it will be appreciated that many variations, modifications and other applications of such embodiments may be made. In general, the disclosure is to be understood as not limited by the specific embodiments described herein, but only by the scope of the appended claims.

What is claimed is:

1. A lens assembly comprising: from an object side to an image side,
seven lens elements numbered L1-L7;
an optical window; and
an image sensor having a sensor diagonal length SDL,
wherein the lens assembly has a total track length TTL, an effective focal length EFL, a field of view FOV<90 degrees and a f number f/#<2, wherein TTL/SDL<0.64, wherein lens element L1 is convex on the object side, wherein the seven lens elements are all made of plastic, and wherein a power sign sequence of the seven lens elements numbered L1-L7 is +−+−++−.

2. The lens assembly of claim 1, wherein TTL/EFL<1.100.

3. The lens assembly of claim 1, each lens element has a clear aperture CA, and wherein the CA of lens elements L3 or L4 is the smallest of all CAs in the lens assembly.

4. The lens assembly of claim 1, wherein f/#<1.9.

5. The lens assembly of claim 1, wherein f/#≤1.8.

6. The lens assembly of claim 2, wherein TTL/EFL<1.090.

7. The lens assembly of claim 1, wherein TTL/SDL<0.63.

8. The lens assembly of claim 1, wherein TTL/SDL<0.61.

9. The lens assembly of claim 1, wherein each lens element has a respective central thickness CT, and wherein the CT of at least 6 of the 7 lens elements complies CT/TTL<0.07.

10. The lens assembly of claim 1, wherein a focal length f₁ of lens element L1 fulfills f₁<EFL.

11. The lens assembly of claim 10, wherein f₁/EFL<0.85.

12. The lens assembly of claim 1, wherein a focal length f₅ of lens element L5 fulfills |f₅/EFL|>4.0.

13. The lens assembly of claim 1, wherein a focal length f₅ of lens element L5 fulfills |f₅/EFL|>6.0.

14. The lens assembly of claim 1, wherein a focal length f₅ of lens element L5 fulfills |f₅/EFL|>8.0.

15. The lens assembly of claim 1, wherein a focal length f₆ of lens element L6 fulfills f₆/EFL|>15.0.

16. The lens assembly of claim 1, wherein a focal length f₆ of lens element L6 fulfills f₆/EFL|>30.0.

17. The lens assembly of claim 1, wherein a focal length f₆ of lens element L6 fulfills f₆/EFL|>45.0.

18. The lens assembly of claim 1, wherein SDL=12 mm and wherein FOV<85 degrees.

19. The lens assembly of claim 1, wherein SDL=12 mm and wherein FOV<83 degrees.

20. The lens assembly of claim 1, wherein the lens assembly is included in a smartphone.
